(19) United States
(12) Patent Application Publication
(10) Pub. No.: US 2005/0035861 A1
(43) Pub. Date: Feb. 17, 2005

(54) Identification apparatus for medically related technical accessories and patients

(76) Inventors: Stefan Gliessmann, Concord, CA (US); Andre Hillner, Apolda (DE); Stefan Leidenberger, Effeltrich (DE); Mark Wofford, Martinez, CA (US)

Correspondence Address: SCHIFF HARDIN, LLP;PATENT DEPARTMENT, 6600 SEARS TOWER, CHICAGO, IL, 60606-6473, US

(21) Appl. No.: 10/859,271

(22) Filed: Jun. 2, 2004

Related U.S. Application Data
(60) Provisional application No. 60/479,299, filed on Jun. 18, 2003.

(51) Int. Cl. G08B 13/14

(52) U.S. Cl. 340/572.1

(57) ABSTRACT

An apparatus for identification of medically related technical accessories and patients comprises a connected transponder reader and a monitoring device. The transponder reader can read out an accessory transponder attached to a medical accessory (possibly an irradiation mask) and a patient transponder. The monitoring device can acquire information read out from an accessory transponder by the transponder reader as an input signal and, dependent on this input signal, can generate an accessory identification signal. It can also acquire information read out by the transponder reader from a patient transponder as an input signal and, dependent on this input signal, can generate a patient identification signal. The apparatus can be part of a radiation therapy system. A system for identification of medically related technical accessories, comprised of a monitoring device, a transponder reader connected with the monitoring device, and an accessory transponder attached to a medical accessory is also provided.

### CROSS REFERENCE TO RELATED APPLICATIONS

The present application claims the benefit of U.S. Provisional Application No. 60/479,299, filed Jun. 18, 2003, herein incorporated by reference.

### BACKGROUND OF THE INVENTION

The invention concerns an apparatus to identify medically related technical accessories and patients.

The automatic identification of objects is, for example, known from barcode (line code) systems. In these systems, the barcode placed on an object is read by a laser-based reader and can, for example, serve for identification of the object. Such systems are used, among other things, in department stores or logistical control devices.

Aside from barcodes, what are known as transponders are also used that operate not via optical readers but rather on the basis of a radio frequency (RF) transmission. In these systems, the reader transmits electrical energy via RF to the transponder, which is thereby (without its own energy supply) placed in a position to be able to send back a response signal to the reader. A non-volatile storage that contains information that is transmitted to the reader is located in the transponder.

In contrast to barcode systems, transponder systems have the advantage that they are harder to manipulate and are not reliant on optical connections between the reader and object.

In medically related technical applications, individual accessory parts are frequently used in addition to diagnostic or therapeutic apparatuses. For example, in radiation therapy, beam masks separate from the actual radiation therapy system are used to optimally, precisely focus ionizing radiation from a radiation source on a body region of a patient to be irradiated. In the acquisition of x-ray images, separate mountings and identifications, by way of which the body region of the patient to be examined (perhaps an extremity) can be fixed in a position suitable for the x-ray exposure, are frequently used by the actual x-ray system.

Such a medical accessory is used in adaptation to the respective patients or the respective diagnostic or therapeutic measures. For example, masks are separately produced for each patient for use in radiation therapy, and specific brackets respectively serve to fix specific body parts for use in x-ray diagnostics.

Particularly given methods using ionizing radiation, for example, x-ray radiation, unnecessarily implemented irradiation measures must be prevented in order to keep the dosage exposure of the patient as low as possible. Unnecessary irradiation measures can, for example, be caused by use of incorrect medical accessories, for example, incorrect irradiation masks. An error-free association of such accessories with respective patients or with respective measures is therefore extraordinarily important.

Until now, the identification of a medical accessory and its association with a patient or with a medical measure has ensued exclusively via the medical specialist. The patient is recognized using his name, the respective accessory either using a label attached for identification or based on its functionality known to the specialist. Although the association by the specialist ensues with all necessary care, this association is still subject to human error.

### SUMMARY OF THE INVENTION

The invention is based on the object to provide one or both apparatuses that enables the automatic identification of medical accessories. The invention is based on the further object to provide an apparatus for the automatic identification of medical accessories and patients.

The invention achieves these objects via an apparatus, via a medical accessory, and via a system with the subsequently specified features.

The invention is based on the idea of providing an apparatus to identify medical accessories and patients with a transponder reader and a monitoring device connected with this. The transponder reader is fashioned such that it can read out an accessory transponder attached to a medical accessory and a patient transponder. The monitoring device is fashioned such that it acquires information read out from an accessory transponder by the transponder reader as an input signal. Dependent on this input signal, it can generate an accessory identification signal, and it acquires information read out by the transponder reader from a patient transponder as an input signal and, dependent on this input signal, can generate a patient identification signal.

The embodiments of the invention are based on the further idea to provide a medical accessory that comprises an accessory transponder that is fashioned such that it can be read out by a transponder reader and from which information can be read out, dependent on which the accessory can be identified.

The embodiments of the invention are based on the further idea to provide a system to identify medically related technical accessories that is comprised of a monitoring device, a transponder reader connected with the monitoring device, and an accessory transponder connected to a medically related technical accessory. The transponder reader is fashioned such that it can read out the accessory transponder. The monitoring device is fashioned such that it can acquire information read out from an accessory transponder by the transponder reader as an input signal and, dependent on this input signal, can generate an accessory identification signal.

An advantageous embodiment of the system comprises a patient transponder, whereby the transponder reader is fashioned such that it can read out the patient transponder, and whereby the monitoring device is fashioned such that it can acquire information read out from a patient transponder by the transponder reader as an input signal and can generate a patient identification signal dependent on this input signal.

Advantageously, the association of a medically related technical accessory with a diagnostic or therapeutic measure via the identification using an accessory transponder can be automatically checked, and human error can thus be eliminated. If the patient is also automatically identified using a patient transponder, he can also be recognized automatically and thereby nearly without possibility of error.

Transponder systems and their handling are simple and can be used in a cost-effective manner. Moreover, transponders can be fashioned without anything further such that they are insensitive to body fluids, medical substances, or other interfering influences that are unavoidable in the medical working environment.

In particular, after availability of the accessory and patient identification signal, it can also be automatically determined whether the accessory necessary for the respective patient has been correctly selected or whether a wrong selection exists. This is particularly important for applications of radiation therapy in which the radiation mask individual to the patient must be used for each patient.

An advantageous embodiment of the invention exists in that the monitoring device of the apparatus is fashioned such that, dependent on the accessory identification signal and the patient identification signal, it can generate a monitoring signal that is emitted as an output signal. The advantage thereby results that the monitoring device can automatically generate a monitoring signal that comprises information about the accuracy of the association between patient and accessory and, for example, can be drawn upon to prevent erroneous associations and, as a result thereof, unnecessary or wrong irradiation measures. For example, the monitoring signal can be output as an optical or acoustic warning signal, or it can be supplied as an electrical signal to the control device of a therapeutic or diagnostic apparatus.

A further advantageous embodiment of the invention exists in that the monitoring device is fashioned such that it can emit the accessory identification signal and/or the patient identification signal as an output signal.

In a further advantageous embodiment of the invention, the transponder reader is fashioned such that it operates with a transmission and reception frequency of 100 kHz to 150 kHz. The specified frequency range lies below the long-wave broadcast range and therefore does not interfere with this. Moreover, the selected frequency is suitable to transmit information even through liquid, gaseous or solid material. A readout of the transponder can thus also ensue when, for example, the patient or another person is located between the patient transponder and the transponder reader.

A further advantageous embodiment of the invention exists in a radiation therapy system that comprises an apparatus of the specified type.

An advantageous embodiment of the invention exists in that the accessory transponder, which is comprised by the medical accessory, operates with a transmission and reception frequency of 100 kHz to 150 kHz.

A further advantageous embodiment of the invention exists in that the medically related technical accessory is fashioned as an irradiation mask.

### DESCRIPTION OF THE DRAWING

Further advantageous embodiments of the invention result from the embodiment illustrated in the Figure, which shows a radiation therapy system with an apparatus for identification of medically related technical accessories as well as patients.

### DETAILED DESCRIPTION OF THE PREFERRED EMBODIMENTS

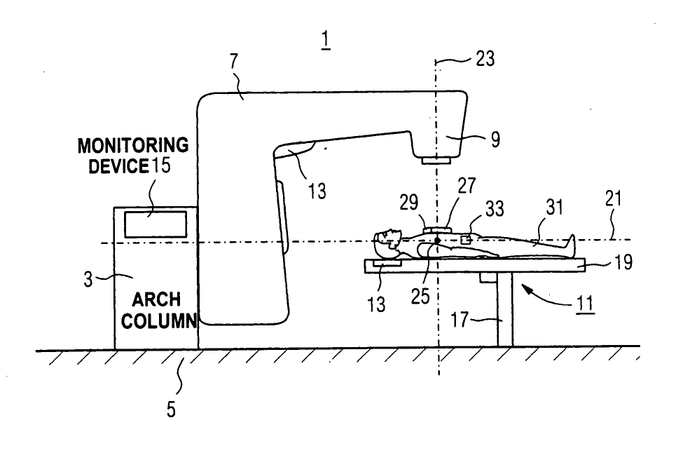

A radiation therapy system 1 to implement a therapeutic irradiation of a patient 31 is shown in FIG. 1. The radiation therapy system 1 comprises an arch column 3 on which it rests and to which is attached a gantry or a frame 7. The gantry 7 bears a radiation source 9 that emits ionizing radiation.

The radiation therapy system 1 also comprises a patient positioning device 11 with a patient bed 19. This is borne by a lifting column 17 such that it can be adjusted with regard to height, and the patient 31 to be irradiated lies on it.

The ionizing beam runs from the radiation source 9 along the vertical iso-axis 23 to the patient 31. The position of the horizontal iso-axis 21 in which the radiation is effective results depending on the radiation used and its penetration depth. What is known as the treatment isocenter 25, in which the radiation develops its maximum effectiveness, lies at the intersection point of the horizontal iso-axis 21 and the vertical iso-axis 23.

In order to achieve an optimal effect of the radiation treatment, the body region of the patient 31 to be treated must lie optimally precisely in the treatment isocenter 25. Misalignments of the patient 31 with regard to the treatment isocenter 25 lead to a lower efficiency of the irradiation measure and will likely be compensated for by re-irradiations. This thus causes an overall increased radiation exposure, and moreover causes the undesired irradiation of body regions other than that to be treated.

In order to achieve an optimally precise focusing on the body region to be irradiated, an irradiation mask 27 is used. The irradiation mask 27 is individually adapted to the respective patient 31. Such masks 27 lie exactly and reproducibly on the patient 31 and comprise a beam penetration window through which the radiation can arrive exclusively at the body region to be treated. With the aid the irradiation mask 27, a reliable positioning of the patient or the body region to be treated is achieved at the treatment isocenter 25.

However, errors in the alignment of the patient 31 can ensue via use of an incorrect irradiation mask 27. In order to prevent this, a monitoring system is provided for automatic identification of the irradiation mask 27 and the patient 31.

The monitoring system is comprised of a transponder reader (RFID) 13 that is integrated into the patient positioning device 11 or into the gantry 7, as well as a monitoring device 15. A plurality of transponder readers 13 can also be provided. The transponder reader or readers 13 are connected with a monitoring device 15 from which they can be controlled and to which they can transmit information.

The system is further comprised of an irradiation mask 27 that comprises a mask transponder 29. This can be read out by the transponder reader or readers 13. The mask transponder 29 or also another accessory transponder for medical accessories enables the readout of information that enables an unambiguous identification of the irradiation mask 27 or the accessory.

In an advantageous embodiment, the system can additionally comprise a patient transponder 33. This can likewise be read out by the transponder reader or readers 13. The patient transponder 33 permits the readout of information that enables an unambiguous identification of the patient 31. It can, for example, be executed as a flat chip and be glued to the skin of the patient by way of, e.g., adhesive tape. The patient transponder 33 can thus be implemented such that it is insensitive to body fluids, pharmaceuticals, laboratory chemicals and other interfering influences. In the event that a reuse is provided, it can moreover also be fashioned to be insensitive to corresponding cleaning measures.

The monitoring device 15 reads out the mask transponder 29 by way of the transponder readers 13. Information for clear identification of the irradiation mask 27 exists in the monitoring device 15. From this information, it generates an accessory identification signal, using which an automatic check of the correct use of the irradiation mask 27 can be effected.

If the system additionally also comprises a patient transponder 33, this is likewise read out. The readout of the patient transponder 33 and the mask transponder 29 can ensue simultaneously or in quick temporal succession in order to increase the confidence of the test. After the readout of the patient transponder 33, additional information for clear identification of the patient 31 exists in the monitoring device 15, and it can generate a patient identification signal. The correct association between patient 31 and mask 27 can be automatically checked from the patient identification signal together with the accessory identification signal.

The identification signals can be emitted by the monitoring device 15 as an output signal to a control device of the radiation therapy system 1. Or, the monitoring device 15, dependent on both identification signals, can generate a monitoring signal that comprises information about the correct use of the irradiation mask 27 or its association with the respective patient 31.

In a first embodiment of the system, the patient transponder 33 and the mask transponder 29 are selected such that their identification signals are identical; in this embodiment, the monitoring device 15 checks their coincidence and requires no further information to generate the monitoring signal. If the identification signals agree, a positive monitoring signal is generated.

In a second embodiment, the identification signals are different, and their mutual association is stored in a storage location; the monitoring device 15 has access to this storage. The association can, for example, exist in a tabular listing of identification signals associated with one another in pairs. The monitoring device 15 tests the association using a comparison of the identification signals with pairs stored in the storage. If the read-out signals of the patient transponder 33 and the mask transponder 29 are stored as a pair in the storage, the correct irradiation mask 27 has been selected and the monitoring device 15 generates a positive monitoring signal.

In the event that an incorrect association is determined, a negative monitoring signal is generated, upon which an optical or acoustic warning is output for an operating personnel. Moreover, the monitoring signal can be given to the control device of the radiation therapy system 1, and, via this, the triggering of an irradiation of the patient 31 can be automatically prevented.

The monitoring system made up of the monitoring device 15, transponder reader 13 and patient transponder 33 as well as mask transponder 29 can operate with radio waves of a frequency from 100 kHz to 150 kHz. Advantageously, these frequencies do not interfere with long-wave radio signals; additionally, they permit the transmission of information, for example, also through the patient 31 or an operating personnel. Moreover, they enable the use of the transponder principle, i.e., a transmitter operating without its own energy supply on the side of the mask transponder 29 and the patient transponder 33.

The transmission of the information can ensue in full-duplex operation depending on the need. The information to be read out can be wired in hardware in the transponder via a diode matrix such that it cannot be manipulated. The modulation of the information to be transmitted can ensue via phase shift keying (PSK), in which the amplitude and frequency of the transmission signal are not changed. The signal is hereby susceptible to interfering pulses in only a slight degree.

The specified monitoring system can also be used for identification of other medically related technical accessories than irradiation masks 27, for example, an accessory that is to be attached to the patient positioning device 11 for implementation of a specific medical measure. In this use, for example, the existence of accessories necessary for a diagnosis or therapeutic measure can be monitored. The accessory transponder can comprise activation switches that activate the transmission operation only upon attachment of the accessory to the patient positioning device 11. In this manner, transponders of an accessory that is not in use are deactivated in order to reduce the number of RF signals and to thereby prevent interfering influences. The monitoring system can not only check to see whether an incorrect accessory is present, but for completeness, i.e., too many or to few accessories.

The specified monitoring system can also be used to identify accessories for use in x-ray apparatuses, for example, holding devices for what are known as held exposures, in which the body region or extremity to be examined must be fixed in a specific position, or, for example, labels to register the body side (right or left) or the x-ray exposure type.

The transponder readers 13 can spatially be aligned such that they can detect only transponders in the spatial environment of the patient positioning device 11. Moreover, the transmission power of the transponder readers 13 as well as the transponder can be selected so low that possible transponders located in the further surroundings cannot be addressed by the transponder readers 13.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

Reference List

1 radiation therapy system
3 arch column
5 floor
7 gantry, frame
9 irradiation source
11 patient positioning device
13 transponder reader (RFID)
15 monitoring device
17 lifting column
19 patient bed, table top
21 horizontal iso-axis
23 vertical iso-axis
25 treatment isocenter
27 irradiation mask
29 mask transponder
31 patient
33 patient transponder

1. An apparatus for identifying medical accessories and patients, comprising:
a transponder reader comprising an input that is configured to read out an accessory transponder attached to a medical accessory and a patient transponder attached to a patient; and
a monitoring device connected to the transponder reader, comprising:
an input that is configured to acquire information read out from the accessory transponder by the transponder reader as an accessory input signal, and configured to acquire information read out from the patient transponder by the transponder reader as a patient input signal; and
an output at which, depending on the accessory input signal, an accessory identification signal is generated, and at which, depending on the patient input signal, a patient identification signal is generated.

2. The apparatus according to claim 1, wherein the monitoring device further comprises a monitoring signal generator by which the monitoring device, dependent on the accessory identification signal and the patient identification signal, generates a monitoring signal that can be output as an output signal.

3. The apparatus according claim 1, wherein the monitoring device further comprises a mechanism for emitting at least one of the accessory identification signal and the patient identification signal as an output signal.

4. The apparatus according to claim 1, wherein the transponder reader is configured to operate with a transmission and reception frequency of 100 kHz to 150 kHz.

5. The apparatus according to claim 1, wherein the monitoring device comprises checking logic configured to determine if the medical apparatus is properly associated with the patient, the monitoring device being configured to produce an output signal if it is not.

6. The apparatus according to claim 5, wherein the checking logic is configured to determine if too many or too few medical accessories are present.

7. A radiation therapy system that comprises an apparatus according to claim 1.

8. A medical accessory comprising an accessory transponder configured to be read out by a transponder reader, and from which information is read out, dependent on which the accessory can be identified.

9. The medical accessory according to claim 8, wherein the accessory transponder operates with a transmission and reception frequency of 100 kHz to 150 kHz.

10. The medical accessory according to claim 8 that is fashioned as an irradiation mask.

11. A system for identifying medical accessories, comprising:
a medical accessory having an attached accessory transponder;
a transponder reader having an input configured to read out information of the accessory transponder;
a monitoring device connected with the transponder reader, comprising:
an input by which it acquires the information read out from the accessory transponder by the transponder reader as an input signal, and;
an accessory identification signal generator by which, depending on the input signal, generates an accessory identification signal.

12. The system according to claim 11, further comprising:
a patient transponder;
wherein the transponder reader input is configured to read out information of the patient transponder; and
wherein the monitoring device input is configured to acquire information read out from the patient transponder by the transponder reader as an input signal, the monitoring device further comprising a patient identification signal generator by which, dependent on this input signal, generates a patient identification signal.

13. The system according to claim 12, wherein the monitoring device further comprises a monitoring signal generator by which, depending on the accessory identification signal and the patient identification signal, generates a monitoring signal that the monitoring device emits as an output signal.
